(19) United States
(12) Patent Application Publication
(10) Pub. No.: US 2004/0019761 A1
(43) Pub. Date: Jan. 29, 2004

(54) Flash storage medium having a NAND-type flash memory

(75) Inventor: Tomoya Fukuzumi, Tokyo (JP)

Correspondence Address: MCDERMOTT, WILL & EMERY, 600 13th Street, N.W., Washington, DC, 20005-3096, US

(73) Assignee: Mitsubishi Denki Kabushiki Kaisha

(21) Appl. No.: 10/374,130

(22) Filed: Feb. 27, 2003

(30) Foreign Application Priority Data
Jul. 25, 2002 (JP) P2002-216911

(51) Int. Cl. G06F 12/10; G06F 12/00

(52) U.S. Cl. 711/202; 711/103

(57) ABSTRACT

A flash storage medium includes a means which converts logical sector addresses inputted from a predetermined host apparatus to logical cluster addresses constituted by logical sector addresses, to control medium inside based upon a cluster unit constituted by sectors that form an access unit to flash memory. A user block area constituted by flash memory physical blocks corresponding to the logical cluster addresses and an erasing block area constituted by flash memory physical blocks in an erased state are specified in said flash memory. Furthermore, the storage medium includes a means which acquires said physical blocks associated with each other from said logical sector addresses when there is a logical cluster address having two physical blocks associated with each other, and effective and ineffective data are respectively located on these two blocks, and a means which exchanges a physical block between said erasing block area and said user block area.

### BACKGROUND OF THE INVENTION

1. Field of the Invention

The present invention relates to a flash storage medium having a NAND-type flash memory.

2. Description of the Related Art

As has been conventionally known, flash storage media, such as compact flash and smart media, have been widely used as media that are detachably attached to various apparatuses, and record texts, images or music information, in order to exchange data among apparatuses such as personal computers, digital cameras or PDAs. Each of these flash storage media is provided with a non-volatile flash memory from and to which data erasing and writing are carried out electrically, and with respect to such a flash memory, in general, a NAND-type flash memory, which has high data erasing and writing speeds and is well-suited for a large capacity storage, has been used.

The NAND-type flash memory has a circuit construction in which storage-use transistors, which form pairs, and have 8 bits or 16 bits, are series-connected, with two selection-use transistors being connected to each pair, and in the flash memory having such a circuit construction, no data writing process is available unless the data writing end has been erased. For this reason, conventionally, a flash storage medium having a NAND-type flash memory is provided with a sequence of processes in which: physical addresses (addresses that have been assigned to actual memory) are assigned to logical addresses (memory addresses specified by a program) of a flash storage medium, and upon writing data, the physical addresses assigned in association with the specified logical addresses are erased, and the data is then written therein.

Here, in most cases, in a general flash storage medium, the memory access unit (sector) of the flash storage medium itself is smaller than an erasing unit (block) of a NAND-type flash memory. For this reason, in the above-mentioned sequence, upon writing data, data which has been written in a block is temporarily stored, and this is composed with new data to be written so that the resulting data is written therein.

However, in the case when, in such a sequence, a writing process is next carried out on continuous logical addresses, the data to be written needs to be again composed, with the result that wasteful processes occur, causing degradation in the data writing performance of the medium.

### SUMMARY OF THE INVENTION

The present invention has been devised to solve the above-mentioned technical problems, and its objective is to provide a flash storage medium which relates to a flash storage medium having an access unit smaller than an erasing unit of a NAND-type flash memory, and makes it possible to prevent the generation of wasteful processes in a data writing process to continuous logical addresses, and consequently to improve the data writing performance.

In an aspect of the invention, there is provided a flash storage medium which has a NAND-type flash memory and the access unit of the flash memory is smaller than an erasing unit of the flash memory. The flash storage medium is provided with a means which converts logical sector addresses inputted from a predetermined host apparatus to logical cluster addresses constituted by a plurality of logical sector addresses, in order to control the inside of the medium based upon a cluster unit constituted by a plurality of sectors that form the above-mentioned access unit. In the above-mentioned flash memory, a user block area constituted by flash memory physical blocks that correspond to the above-mentioned logical cluster addresses and an erasing block area constituted by flash memory physical blocks that have been set in an erased state are defined. Moreover, the flash storage medium is provided with a means which, when there is a logical cluster address having two flash memory physical blocks that are associated with each other, and when effective data and ineffective data are respectively located on these two flash memory physical blocks, acquires flash memory physical blocks that are associated with each other from logical sector addresses inputted from a host apparatus. Moreover, the flash storage medium has a means which exchanges a flash memory physical block in the above-mentioned erasing block area and a flash memory physical block in the user block area.

### BRIEF DESCRIPTION OF THE DRAWINGS

FIG. 1 is a block diagram that shows an inner structure of a flash storage medium having a NAND-type flash memory in accordance with a first embodiment of the present invention.

FIG. 2 is a drawing that shows a block structure that is defined in the NAND-type flash memory in accordance with the first embodiment of the present invention.

FIG. 3 is a drawing that shows a structure of a pointer table in accordance with the first embodiment.

FIG. 4 is a drawing that shows the relationship between various addresses in a user block area in accordance with the first embodiment of the present invention.

FIG. 5 is a drawing that shows a structure of a user block managing table stored in a user-block managing-table use block area.

FIG. 6 shows a logical cluster address in which effective data is stored in one physical block and a logical cluster address in which effective data is stored in two physical blocks in a divided manner.

FIG. 7 shows a structure of an erasing-block managing table.

FIG. 8 is a drawing that shows a flow chart with respect to an inner process that is executed by a flash storage medium upon receipt of a data-reading request.

FIG. 9 is a drawing that shows a first flow chart with respect to an inner process that is executed by a flash storage medium upon receipt of a data-writing request.

FIG. 10 is a drawing that shows a second flow chart with respect to an inner process that is executed by a flash storage medium upon receipt of a data-writing request.

FIG. 11 is a drawing that shows a third flow chart with respect to an inner process that is executed by a flash storage medium upon receipt of a data-writing request.

FIG. 12 is a drawing that shows a fourth flow chart with respect to an inner process that is executed by a flash storage medium upon receipt of a data-writing request.

FIG. 13 shows a data-writing operation in the case when an inner-table offset value *DIVOFST=0 that is being divided in the user-block managing table.

FIG. 14 shows a data-writing operation in the case when *DIVOFST=x′ and FmPage≧*DIVOFST.

FIG. 15 shows a data-writing operation that is carried out under conditions other than those shown in FIGS. 13 and 14.

FIG. 16 shows a data-writing operation in the case when *DIVOFST=x′ and FmPage=*DIVOFST.

FIG. 17 is a drawing that shows a structure of a user-block managing table in accordance with a second embodiment of the present invention.

FIG. 18 is a drawing that shows a first flow chart with respect to an inner process that is executed by a flash storage media upon receipt of a data-reading request in accordance with the second embodiment.

FIG. 19 is a drawing that shows a second flow chart with respect to an inner process that is executed by a flash storage media upon receipt of a data-writing request in accordance with the second embodiment.

FIG. 20 is a drawing that shows a third flow chart with respect to an inner process that is executed by a flash storage media upon receipt of a data-writing request in accordance with the second embodiment.

FIG. 21 shows a data-writing operation in the case when inner-table offset value that is being divided in the user-block managing table *DIVOFST=0 and ErsFlag of *(SRCBLK+x′)=0.

FIG. 22 shows a data-writing operation in the case when *DIVOFST=x′, FmPage≧*DIVFSCT and ErsFlag of *(SRCBLK+x′)=0.

FIG. 23 shows a data-writing operation in the case when ErsFlag=0 under conditions other than those shown in FIGS. 21 and 22.

### DESCRIPTION OF THE PREFERRED EMBODIMENTS

Referring to the attached drawings, the following description will discuss preferred embodiments of the present invention. The following preferred embodiments will exemplify a case in which the access unit (sector) of a flash storage medium is smaller than the erasing unit (block) of a NAND-type flash memory to be installed therein, and the same as the writing unit (page) thereof.

First Embodiment

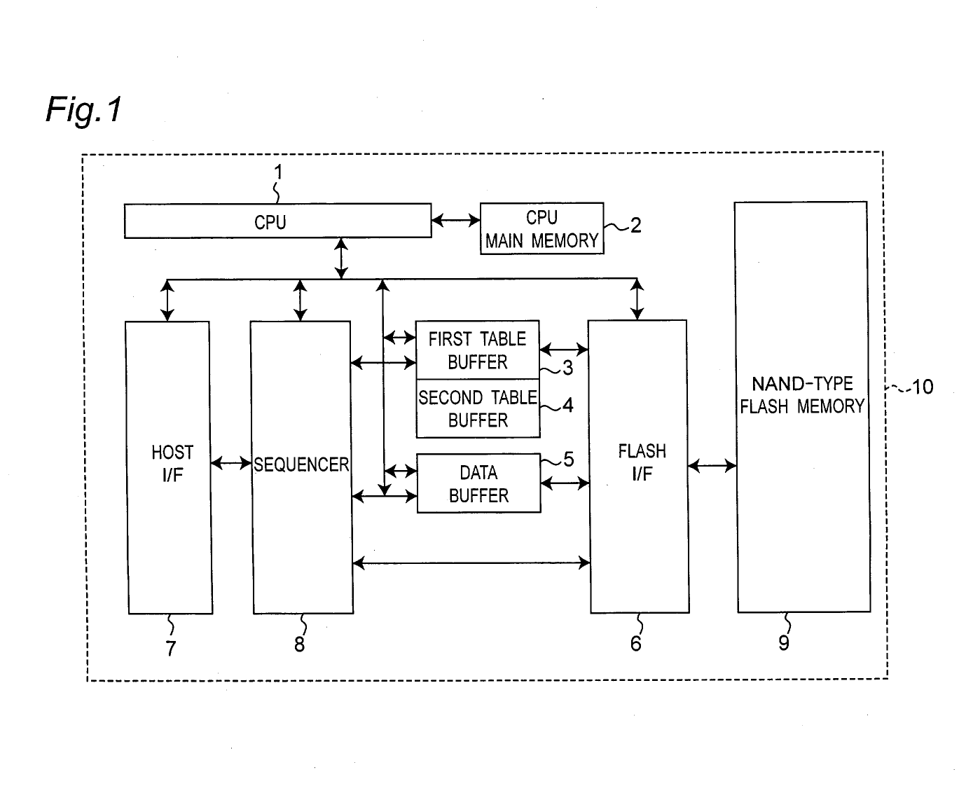

FIG. 1 is a block diagram that shows an inner structure of a flash storage medium in accordance with a first embodiment of the present invention. This flash storage medium 10 is provided with a CPU 1, a CPU main memory 2, first and second table buffers 3 and 4, a data buffer 5, a flash interface (flash I/F in the drawing) 6, a host interface (host I/F in the figure) 7, a sequencer 8 and a NAND-type flash memory (hereinafter, referred to as flash memory) 9.

This CPU 1 controls the inside of the flash storage medium in order to carry out data exchange with devices on the host apparatus (not shown) side, such as a personal computer, a digital camera and a PDA. The CPU main memory 2 stores an operation flow of the CPU 1, and depending on access types given from the host apparatus side, the CPU 1 reads the corresponding flow from the CPU main memory 2, and carries out the operation.

Each of the first and second table buffers 3 and 4 is a buffer memory which reads a pointer table, a user-block managing table or an erasing-block managing table stored in the flash memory 9, and stores it temporarily. The data buffer 5, which reads user data stored in the flash memory 9, and stores the data, is a buffer memory that is used when the data is outputted to the host apparatus, or when data is received from the host apparatus and written in the flash memory 9.

The flash I/F 6 is a unit which generates a signal that is used when an access is made to the flash memory 9. The host I/F 7 is a unit which controls an access signal from the host apparatus. The sequencer 8 is a unit for controlling the access sequence to the flash memory 9 or the data transferring sequence from the host apparatus, and the CPU 1 carries out data input/output operations to and from the host apparatus by using the sequencer 8, and also carries out a data-writing operation to the flash memory 9 or a data-inputting operation from the flash memory 9.

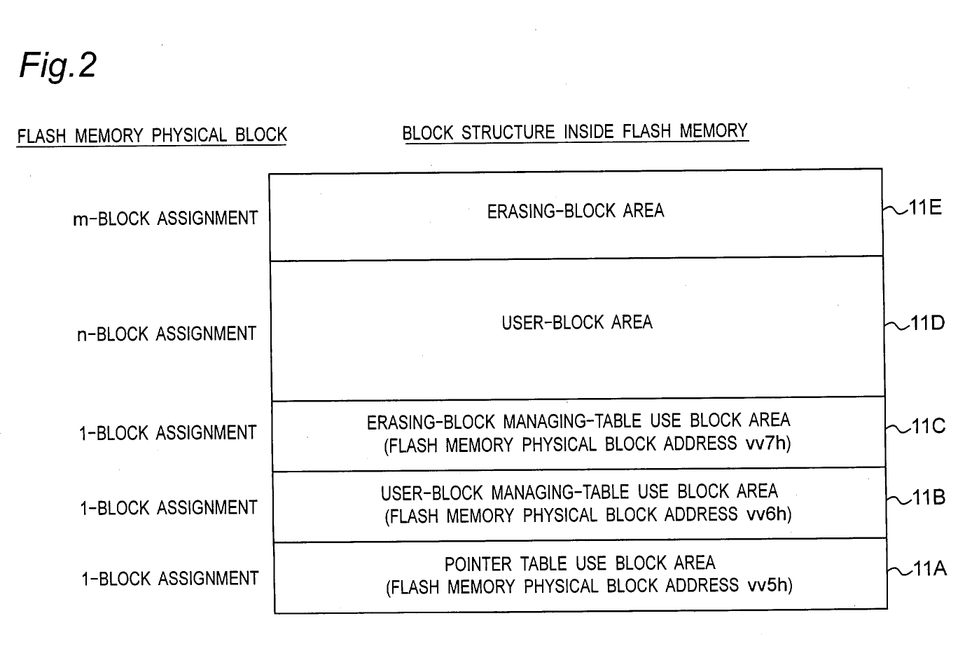

FIG. 2 is a drawing that shows a block structure that is defined in the flash memory 9. As shown in this figure, inside the flash memory 9 are placed block areas for recording specific pieces of information, such as a block area 11A (hereinafter, referred to as a pointer-table-use block area) for storing pointer tables, a block area 11B (hereinafter, referred to as a user-block managing-table use block) for storing a table used for managing a user block area 11D, a block area 11C (hereinafter, referred to as an erasing-block managing-table use block) for storing a table for managing an erasing block area 11E, a user-block area 11D and an erasing-block area 11E. Each of the block areas has a predetermined number of physical blocks assigned thereto among the total physical blocks in the flash memory 9.

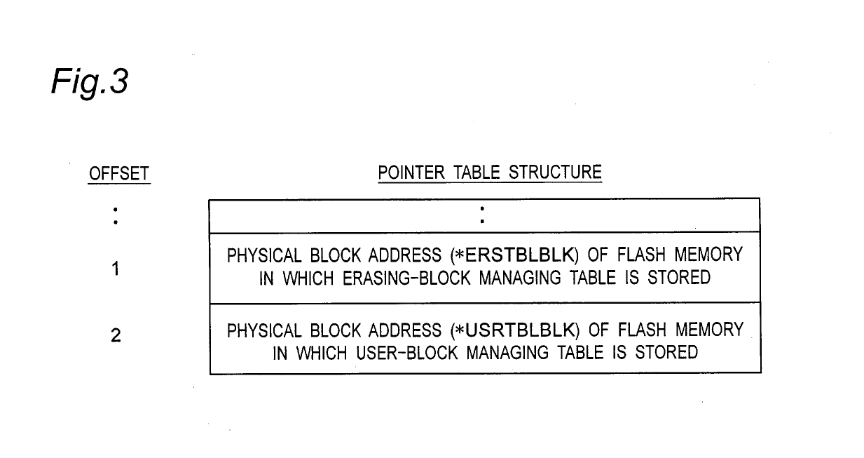

First, one unit of physical blocks is assigned to the pointer-table use block area 11A. FIG. 3 shows a structure of a pointer table to be stored in the pointer-table use block area 11A. In the pointer table are stored physical block addresses of the flash memory 9 that represent the positions of various pieces of information in the address space of the flash memory 9, such as physical block addresses *USRTBLBLK of the flash memory 9 in which the user-block managing table is stored and physical block addresses *ERSTBLBLK in which the erasing-block managing table is stored.

Such a pointer table is designed to be stored at physical block address “0” in the flash memory 9, and the CPU 1 first reads out the pointer table onto the first table buffer 3, and the values of the above-mentioned physical block addresses *USRTBLBLK and *ERSTBLBLK are stored in the table buffer 3.

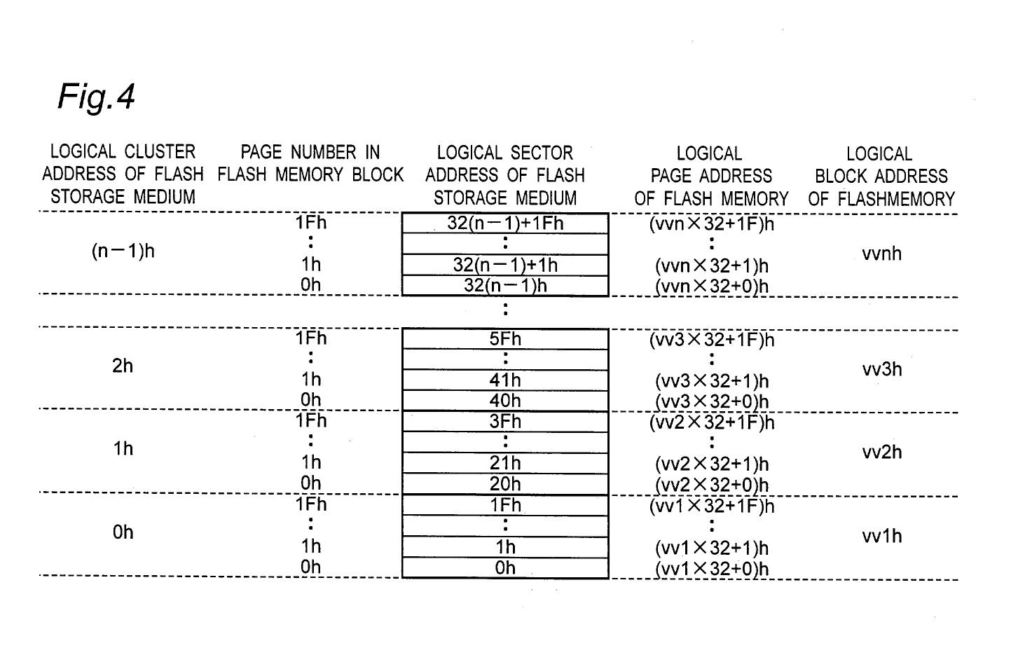

Moreover, as shown in FIG. 2, one unit of physical blocks is assigned to the user-block managing-table use block area 11B. FIG. 4 shows the structure of the user-block area 11D whose address is controlled by the user block managing table. In the present preferred embodiment, one physical sector address of the flash memory 9 corresponds to a logical sector address of the flash storage medium 10. In this case, continuous sector addresses are assigned to pages in the physical block of the flash memory 9. Moreover, in order to carry out the inner management, a collection of logical sectors constituted by one physical block is set to a logical cluster, one physical block address is assigned to one logical cluster address.

Here, FIG. 4 shows an example in which the physical block of the flash memory 9 is constituted by 32 physical memory pages, and 32 logical sectors constitute one logical cluster. In the user block area 11D, when the flash storage medium 10 has n-number of logical cluster addresses, n-number of physical blocks of flash memory 9 are assigned thereto.

More specifically, logical cluster addresses 0h, 1h, 2h, . . . , (n−1)h of the flash storage medium 10 are respectively assigned to sets of logical sector addresses of the flash storage medium 10 {0h, 1h, . . . , 1Fh}, {20h, 21h, . . . , 3Fh}, {40h, 41h, . . . , 5Fh}, . . . , {32(n−1)h, 32(n−1)+1h, . . . , 32(n−1)+1Fh}. The sets of logical sector addresses of this flash storage medium 10 respectively correspond to the sets of physical sector addresses of the flash memory 9. For example, the logical sector addresses 20h, 21, . . . , 3Fh, that constitute the sets of sector addresses {20h, 21h, . . . , 3Fh} of the flash storage medium 10 respectively correspond to physical sector addresses (vv2×32+0)h, (vv2×32+1)h, . . . , (vv2×32+1F)h of the flash memory 9.

Moreover, the sets of physical sector addresses of the flash memory 9 are respectively assigned to the physical block addresses of the flash memory 9. For example, sets of physical sector addresses, constituted by physical sector addresses (vv1×32+0)h, (vv1×32+1)h, . . . , (vv1×32+1F), are assigned to physical block addresses vv1h, and sets of physical sector addresses, constituted by (vvn×32+0)h, (vvn×32+1)h, . . . , (vvn×32+1F), are assigned to physical block addresses “vvnh”.

Consequently, as described earlier, the logical cluster addresses 0h, 1h, 2h, . . . , (n−1)h of the flash storage medium 10 are made to respectively correspond to physical block addresses vv1h, vv2h, vv3h, . . . , vvnh of the flash memory 9.

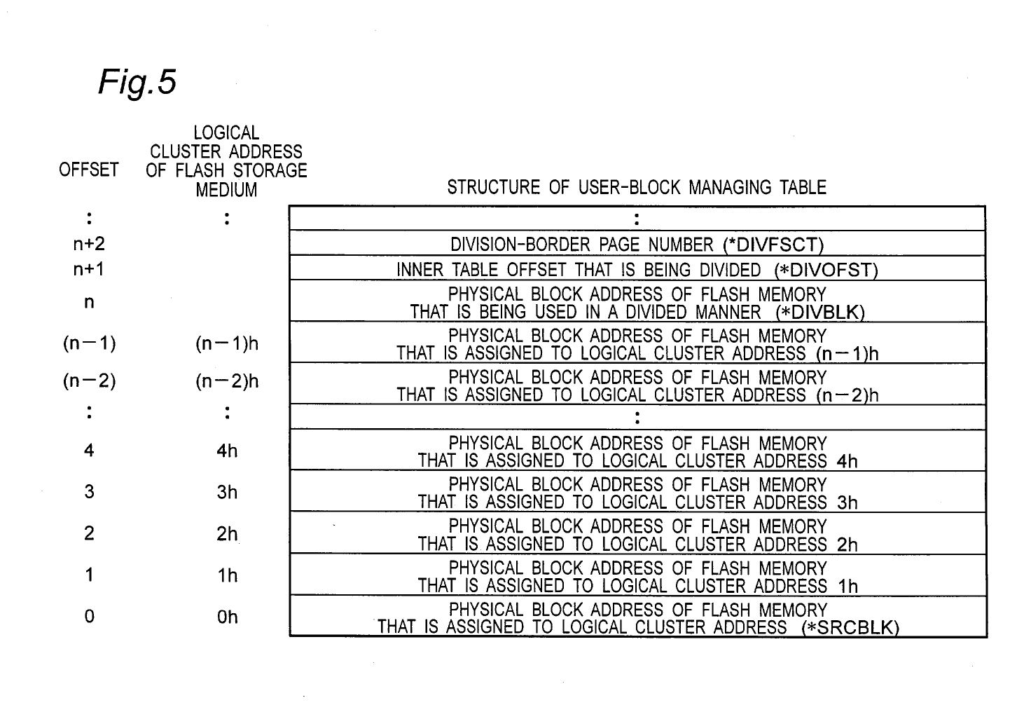

Moreover, FIG. 5 shows the structure of the user-block managing table to be stored in the user-block managing-table use block area 11B. In respective offsets, 0, 1, 2, 3, 4, . . . , n−2, n−1, are stored physical block addresses of the flash memory 9 assigned to the respective logical cluster addresses 0h, 1h, 2h, 3h, 4h, . . . , (n−2)h, (n−1)h.

Furthermore, in the user-block managing-table use block area 11B, with respect to offsets in a higher order hierarchy than the offsets in which physical block addresses of the flash memory 9 assigned to the respective logical cluster addresses of the flash storage medium 10 are stored, physical block addresses *DIVBLK of the flash memory 9 that are being used in a divided manner, inner-table offsets *DIVOFST that are being divided, division-border page numbers *DIVFSCT, etc. are stored.

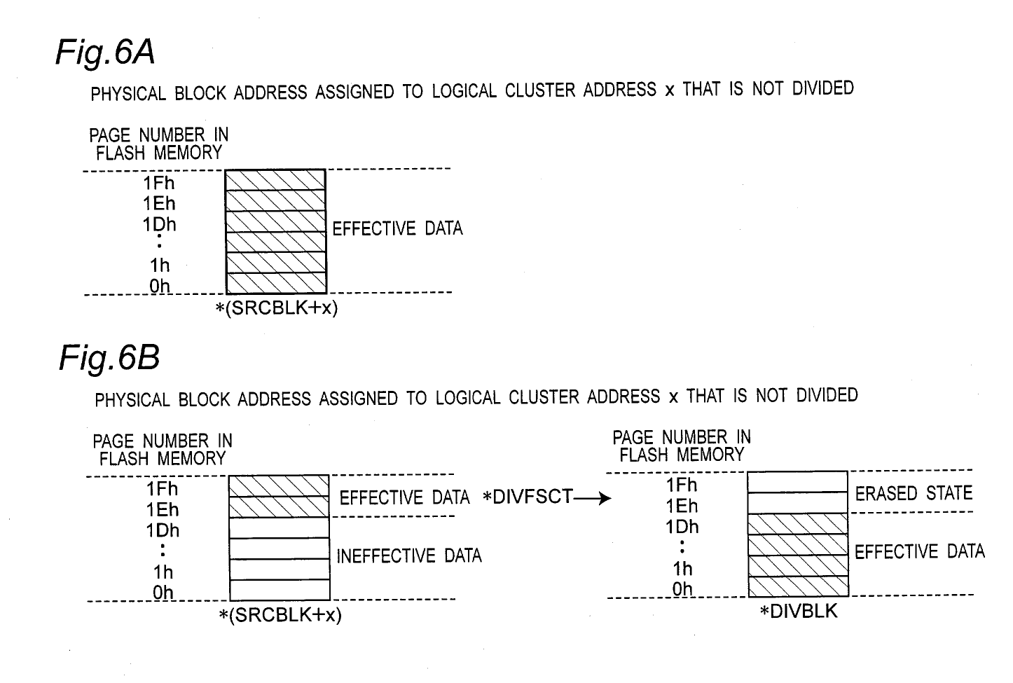

Here, in the user-block area 11D, there are a logical cluster address in which effective data for one logical cluster address x is stored in a physical block in one flash memory 9 as shown in FIG. 6A, and a logical cluster address in which effective data is stored in physical blocks of two flash memories 9 in a divided manner, as shown in FIG. 6B.

Here, in the figure, “effective data” refers to necessary data written in a predetermined physical block address, while “ineffective data” refers to unnecessary data although it is written in a predetermined physical block, and “erased state” refers to a state in which no data exists.

Here, the inner-table offset that is being divided represents a logical cluster address that is divided into two physical blocks of the flash memory 9 and stored. As shown in FIG. 6B, the effective data of the logical cluster address is divided into pages of not less than the division-border page number *DIVFSCT of the physical block address *(SRCBLK+*DIVOFST) of the flash memory 9 stored in the offset *DIVOFST of the user-block managing table and pages in a higher order hierarchy than the division border page number *DIVFSCT of the physical block address *DIVBLK of the flash memory that is being used in a divided manner, and stored.

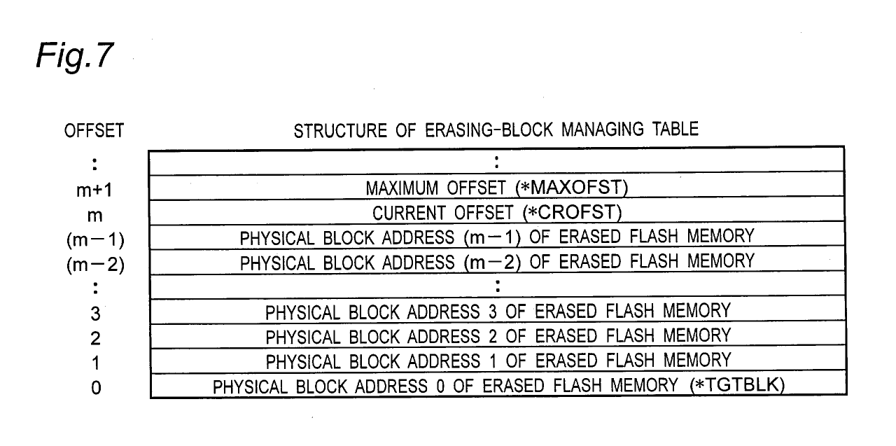

Next, the following description will discuss the erasing-block managing-table use block 11C. As shown in FIG. 2, in the flash memory 9, one physical block address is assigned to the erasing-block managing-table use block area 11C. FIG. 7 shows a structure of the inside of the erasing-block managing-table use block area 11C. To the erasing-block managing-table use block area 11C are assigned physical block addresses 0, 1, 2, 3, . . . , m−2, m−1 of the flash memory 9, which have been erased. Here, m represents the number of physical blocks to be assigned to the erasing block area 11E. Supposing that the total number of effective physical blocks in the flash memory is “TotalBIk”, m represents the number of physical blocks that are left after n-blocks have been assigned to the user-block area 11D, one block has been assigned to the erasing-block managing-table use block area 11C, one block has been assigned to the user-block managing-table use block area 11B and one block has been assigned to the pointer-table use block area 11A, and it is indicated by m=TotalBlk−n−1−1−1.

As shown in FIG. 7, in the erasing-block managing-table use block area 11C are stored a current offset *CUROFST, a maximum offset *MAXOFST in addition to the physical block addresses that have been erased. The “current offset” refers to an offset in which a physical block address that has been removed from a flash memory 9 to be used next is stored, and the “maximum offset”, on the other hand, represents the number of physical block addresses that have been erased from the flash memory 9 to be stored in the erasing-block managing-table.

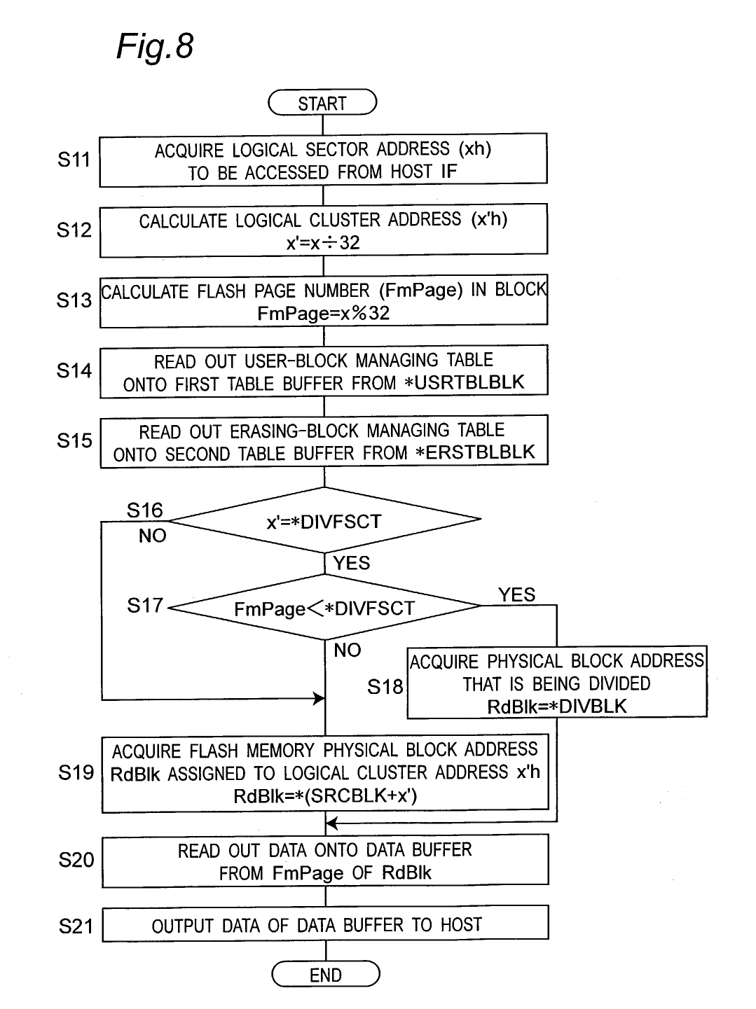

Next, FIG. 8 shows a flow chart with respect to the inner processes of the flash storage media 10 upon request of a data-reading operation of a logical sector address xh from the host apparatus side. In these processes, first, in step 11 (hereinafter, indicated as S11), a logical sector address xh to be accessed is acquired from the host I/F 7, and at S12, the corresponding logical cluster address x′h is calculated from the logical sector address xh based upon the following equation:

x′=x/32

Successively at S13, the page number FmPage of the flash memory inside the block is calculated by the following equation:

FmPage=x % 32

Next, at S14, based upon the physical block address *USRTBLBLK of the flash memory 9 in which the user-block managing table is stored, a user-block managing table is read out onto a first table buffer 3, and at S15, based upon *ERSTBLBLK that is the physical block address of the flash memory 9 in which the erasing-block managing table is stored, an erasing-block managing table is read out onto the second table buffer 4.

Moreover, at S16, it is determined whether or not x′ calculated at S12 is equal to the value DIVFSCT of the division-border page number inside the user-block managing table (x′=*DIVFSCT). If it is YES, the sequence proceeds to S17, and if it is NO, the sequence proceeds to S19.

At S17, it is determined whether or not the page number FmPage of the flash memory within the block is smaller than the value DIVFSCT of the above-mentioned division-border page number (FmPage<*DIVFSCT).

If it is NO, the sequence proceeds to S19, and after the physical block address RdBlk of the flash memory 9 that was assigned to the logical cluster address x′h (that is, RdBlk=*(SRCBLK+x′)) has been acquired, the sequence proceeds to S20.

In contrast, if it is YES, the sequence proceeds to S18, and after the physical block address RdBlk of the flash memory 9 that is being divided has been acquired (RdBlk=*DIVBLK), the sequence proceeds to S20.

At S20, data is read out onto the data buffer 5 from the page number FmPage of the above-mentioned physical block address RdBlk. Then, finally, the data of the data buffer 5 is outputted to the host apparatus. Thus, the process is completed.

In this manner, in the case when, upon acquiring the physical block address RdBlk of the flash memory 9 assigned to the logical cluster address x′h from the user block managing table, the logical cluster address x′h is divided into two physical blocks, after it has been confirmed which physical block has stored effective data, the RdBlk is acquired, and based upon the RdBlk, data is read, and outputted to the host apparatus.

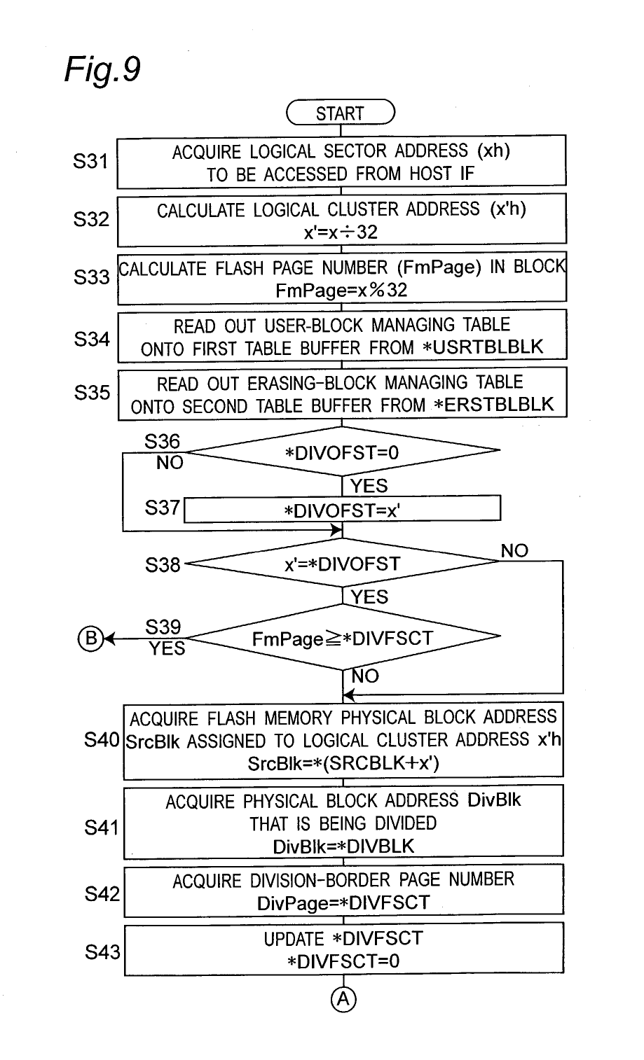

Next, FIGS. 9 to 12 show flow charts with respect to inner processes in the flash storage medium 10 upon request of a data-writing operation to a logical sector address xh from the host apparatus side. In these processes, first, in step 31, a logical sector address xh is acquired from the host I/F 7, and at S32, the corresponding logical cluster address x′h is calculated from the logical sector address xh based upon the following equation:

x′=x/32

Successively at S33, the page number FmPage of the flash memory inside the block is calculated by the following equation:

FmPage=x % 32

Next, at S34, based upon the physical block address *USRTBLBLK of the flash memory 9 in which a user-block managing table is stored, the user-block managing table is read onto a first table buffer 3.

Moreover, at S35, based upon *ERSTBLBLK that is the physical block address of the flash memory 9 in which an erasing-block managing table is stored, the erasing-block managing table is read onto the second table buffer 4.

Moreover, at S36, it is determined whether or not x′ calculated at S12 is equal to the value DIVOFST of the offset inside the table that is being divided in the user-block managing table is 0 (*DIVOFST=0). If it is YES, the sequence proceeds to S37, and after having been recognized that the *DIVOFST is x′ that has been calculated at S32 (*DIVOFST=x′), the sequence proceeds to S38. In contrast, if it is NO, the sequence directly proceeds to S38.

At S38, it is determined whether or not x′=*DIVOFST, and if it is YES, the sequence proceeds to S39, while if it is NO, the sequence proceeds to S40.

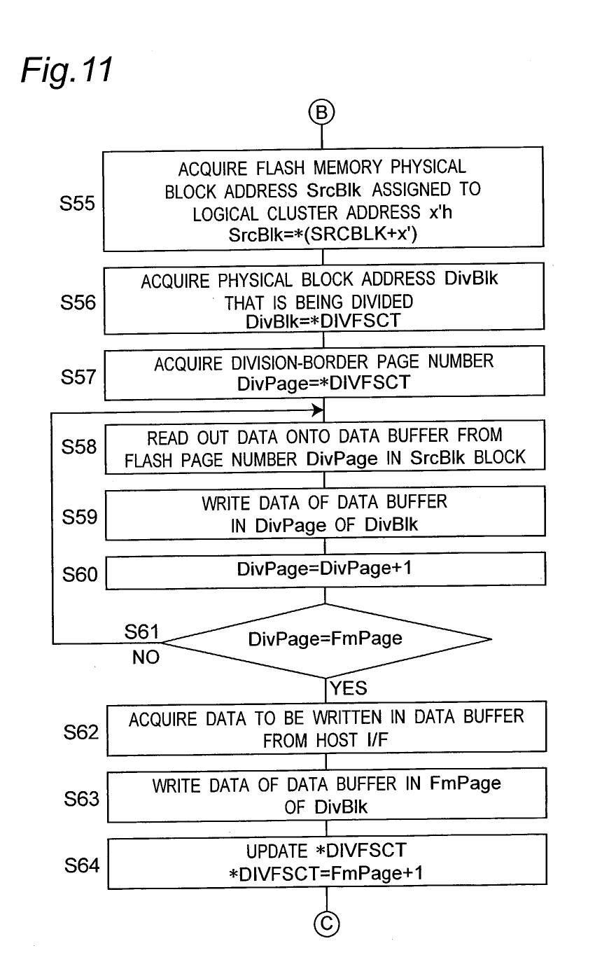

At S39, it is determined whether or not the above-mentioned page number FmPage is not less than the value DIVFSCT (FmPage≧*DIVFSCT) of the division-border page number within the user block managing table, and if it is YES, the sequence proceeds to S55 at FIG. 11 through B in the Figure, and if it is NO, the sequence proceeds to S40.

At S40, the physical block address SrcBlk of the flash memory assigned to the logical cluster address x′h is acquired (that is, SrcBlk=*(SRCBLK+x′)).

Next, at S41, the value *DivBlk of the physical block address of a flash memory that is being used in a divided manner within the user-block managing table is acquired (DivBlk=*DIVBLK) as the physical block address DivBlk that is being divided.

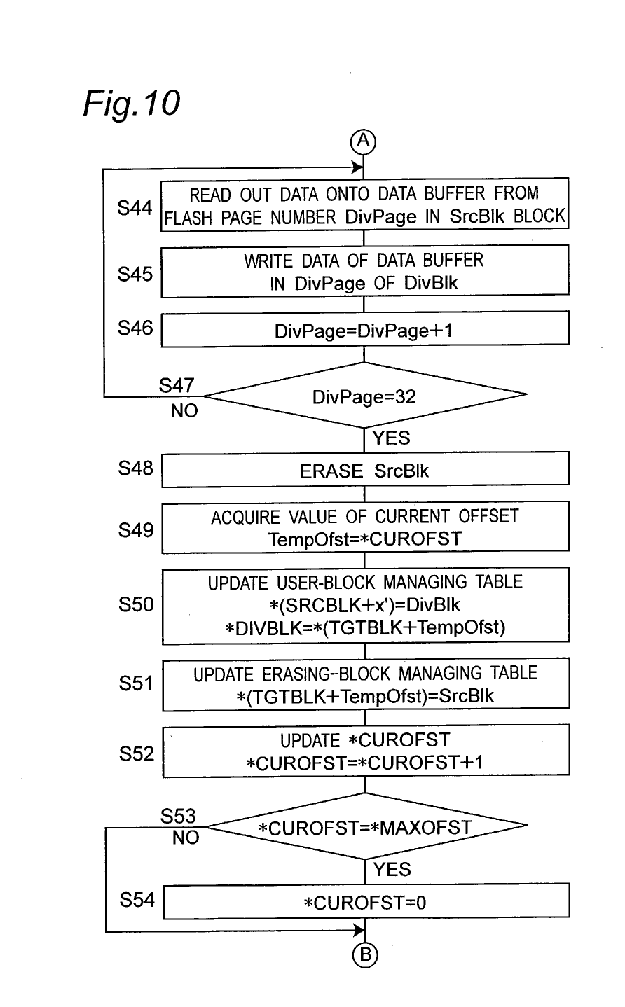

Next, at S42, the value DIVFSCT of the above-mentioned division-border page number (DivPage=*DIVFSCT) is acquired as the page number DivPage (hereinafter, referred to as division-border page number) of the flash memory in the block corresponding to the border, when effective data is stored in two physical blocks as shown in FIG. 6B. Next, at S43, the value *DIVFSCT of the division-border page number within the user-block managing table is updated (*DIVFSCT=0). Then, the sequence proceeds to S44 in FIG. 10 through A in the figure.

At S44, based upon the division-border page number DivPage of the above-mentioned physical block address SrcBlk, data is read out to the data buffer 5.

At S45, the data of the data buffer 5 is written in the division border page number DivPage of the flash memory physical block address DivBlk that is being divided.

At S46, the division-border page number DivPage of the above-mentioned physical block address SrcBlk is updated (DivPage=DivPage+1).

At S47, with respect to the above-mentioned division-border page number DivPage, it is determined whether or not DivPage is 32 (DivPage=32).

If it is YES, the sequence proceeds to S48, while, if it is NO, the sequence returns to S44 where the succeeding processes are repeated.

At S48, the above-mentioned physical block address SrcBlk is erased.

At S49, by setting the offset value as TempOfst, the current offset value *CUROFST is acquired from the erasing-block managing table (TempOfst=*CUROST).

At S50, the user-block managing table is updated. In this case, the following equations are used:

*(SRCBLK+x′)=DivBlk

*DIVBLK=*(TGTBLK+TempOfst)

Here, TGTBLK refers to physical block address 0 of the flash memory that has been erased, and TGTBLK+TempOfst refers to the value of the offset Ofst of the erasing-block managing table.

At S51, the erasing-block managing table is updated. In this case, the following equation is used:

*(TGTBLK+TempOfst)=SrcBlk

Moreover, at S52, the current offset value *CUROFST is updated (*CUROFST=*CUROFST+1).

At S53, it is determined whether or not the above-mentioned current offset value *CUROFST is the maximum offset value *MAXOFST (*CUROFST=*MAXOFST) within the erasing-block managing table. If it is YES, the sequence proceeds to S54, and after having recognized that the current offset value *CUROFST is 0 (*CURSFST=0), the sequence proceeds to S55 of FIG. 11, while, in contrast, if it is NO, the sequence directly proceeds to S55.

At S55, the physical block address SrcBlk of the flash memory that has been assigned to the logical cluster address x′h is acquired (SrcBlk=*(SRCBLK+x′)).

At S56, the physical block address DivBlk that is being divided is acquired (DivBlk=*DIVBLK).

At S57, the division-border page number DivPage is acquired (DivPage=*DIVFSCT).

Moreover, at S58, data is read out onto the data buffer 5 from the division-border page number DivPage of the physical block address SrcBlk of the flash memory that has been assigned to the logical cluster address x′h.

At S59, the data of the data buffer 5 is written in the division-border page number DivPage of the physical block address DivBlk that is being divided.

At S60, the division-border page number DivPage is updated (DivPage=DivPage+1).

At S61, it is determined whether or not the division-border page number DivPage is equal to the page number FmPage of the flash memory in the block (DivPage=FmPage). If it is YES, the sequence proceeds to S62, while, if it is NO, the sequence returns to S58 where the succeeding processes are repeated.

At S62, data to be written in the data buffer 5 is acquired from the host I/F 7.

At S63, the data of the data buffer 5 is written is the page number FmPage of the flash memory in the block of the physical block address DivBlk that is being divided.

At S64, the value *DIVFSCT of the division-border page number within the user-block managing table is updated (*DIVFSCT=FmPage+1).

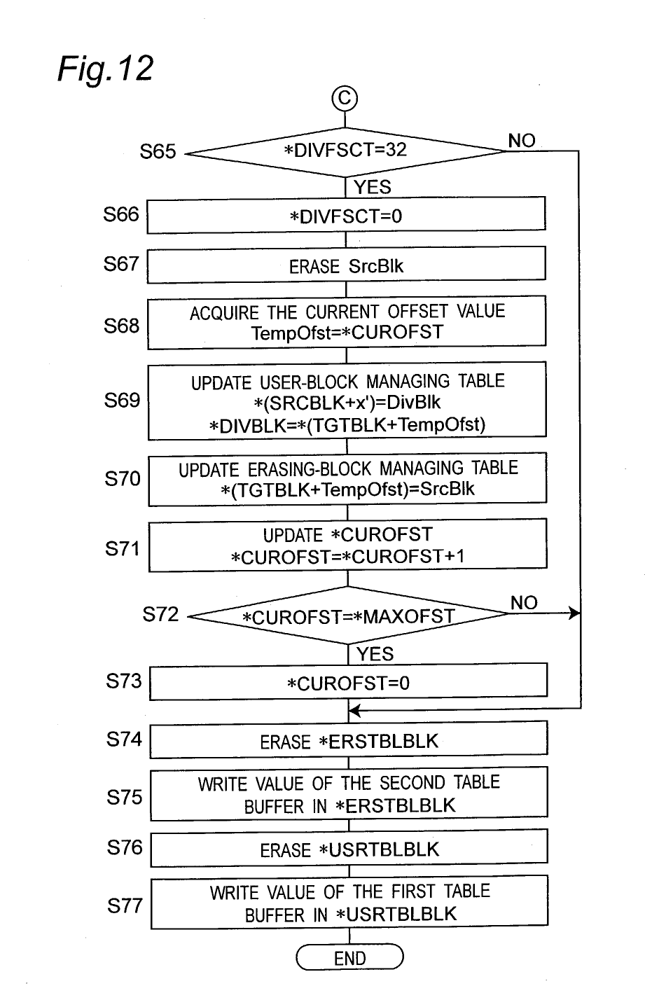

Thereafter, the sequence proceeds to S65 of FIG. 12 through C of the figure.

At S65, it is determined whether or not the value *DIVFSCT of the division-border page number within the user-block managing table is 32 (*DIVFSCT=32). If it is YES, the sequence proceeds to S66, while, if it is NO, the sequence proceeds to S74.

At S66, the value *DIVFSCT of the division-border page number within the user-block managing table is set to 0 (*DIVFSCT=0).

At S67, the above-mentioned physical block address SrcBlk is erased.

At S68, the current offset value *CUROFST is acquired as the offset value TempOfst (TempOfst=*CUROFST).

At S69, the user-block managing table is updated. In this case, the following equations are used:

*(SRCBLK+x′)=DivBlk

*DIVBLK=*(TGTBLK+TempOfst)

At S70, the erasing-block managing table is updated. In this case, the following equation is used:

*(TGTBLK+TempOfst)=SrcBlk

At S71, the current offset value *CUROFST within the erasing-block managing table is updated (*CUROFST=*CUROFST+1).

At S72, it is determined whether or not the current offset value *CUROFST within the erasing block managing table is equal to the maximum offset value *MAXOFST within the erasing-block managing table (*CUROFST=*MAXOFST). If it is YES, the sequence proceeds to S73 where, after *CUROFST=0 has been set, the sequence proceeds to S74. In contrast, if it is NO, the sequence directly proceeds to S74.

At S74, the physical block address *ERSTBLBLK of the flash memory in which the erasing-block managing table has been stored is erased.

At S75, the value of the second table buffer 4 is written in the *ERSTBLBLK that has been subjected to the erasing process.

At S76, the physical block address *USRTBLBLk of the flash memory in which the user-block managing table has been stored is erased.

At S77, the value of the first table buffer 3 is written in the *USRTBLBLK after having been subjected to the erasing process.

Thus, the process is completed.

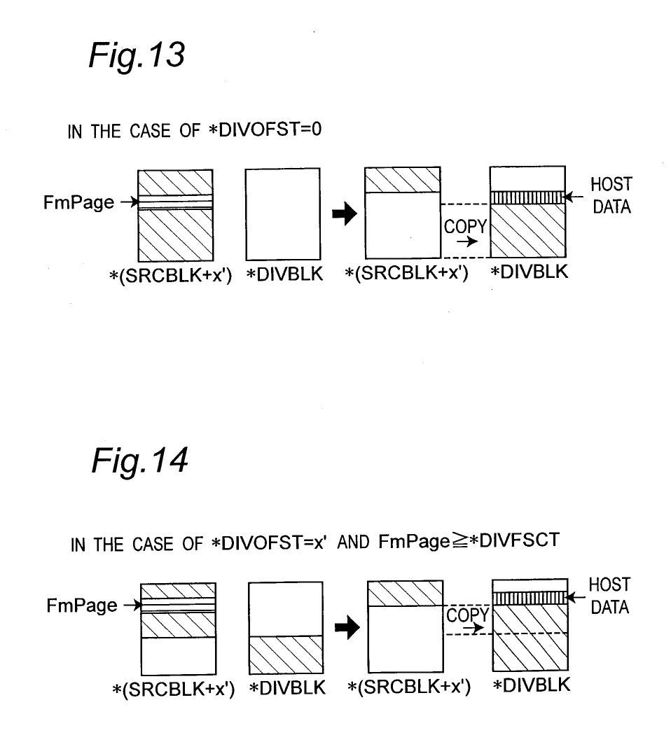

FIGS. 13 to 15 conceptually indicate data-writing operations in accordance with the inner processes by using flowcharts of FIGS. 9 to 12.

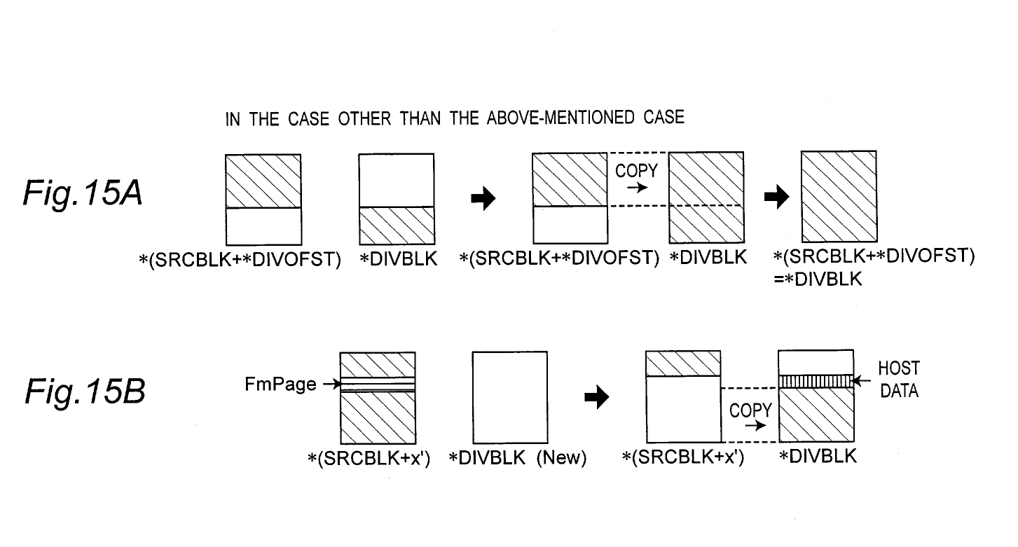

FIG. 13 shows a data-writing operation in the case when the value *DIVOFST of the inner table offset that is being divided within the user-block managing table is 0. Further, FIG. 14 shows a data-writing operation in the case when *DIVOFST=x′ and FmPage≧*DIVOFST. Moreover, FIGS. 15A and 15B show data-writing operations under conditions other than those shown in FIGS. 13 and 14, and FIG. 16 shows a data-writing operation in the case when *DIVOFST=x′ and FmPage=*DIVOFST.

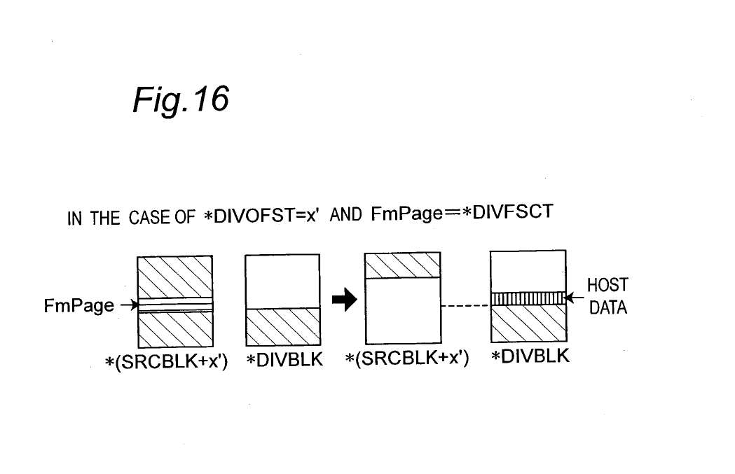

As described above, the inner process is changed depending on cases in which accessing is given to an logical cluster address that is being used in a divided manner and cases in which accessing is given to a logical cluster address other than the address of this type so that, when a writing operation is carried out on continuous logical addresses with respect to the flash strange media, it is possible to eliminate wasteful copying processes as shown in FIG. 16, and consequently to improve writing performances.

Next, the following description will discuss another preferred embodiment of the present invention. Here, those parts having the same functions as those shown in the the first embodiment are indicated by the same reference numerals, and the detailed description thereof is omitted.

Second Embodiment

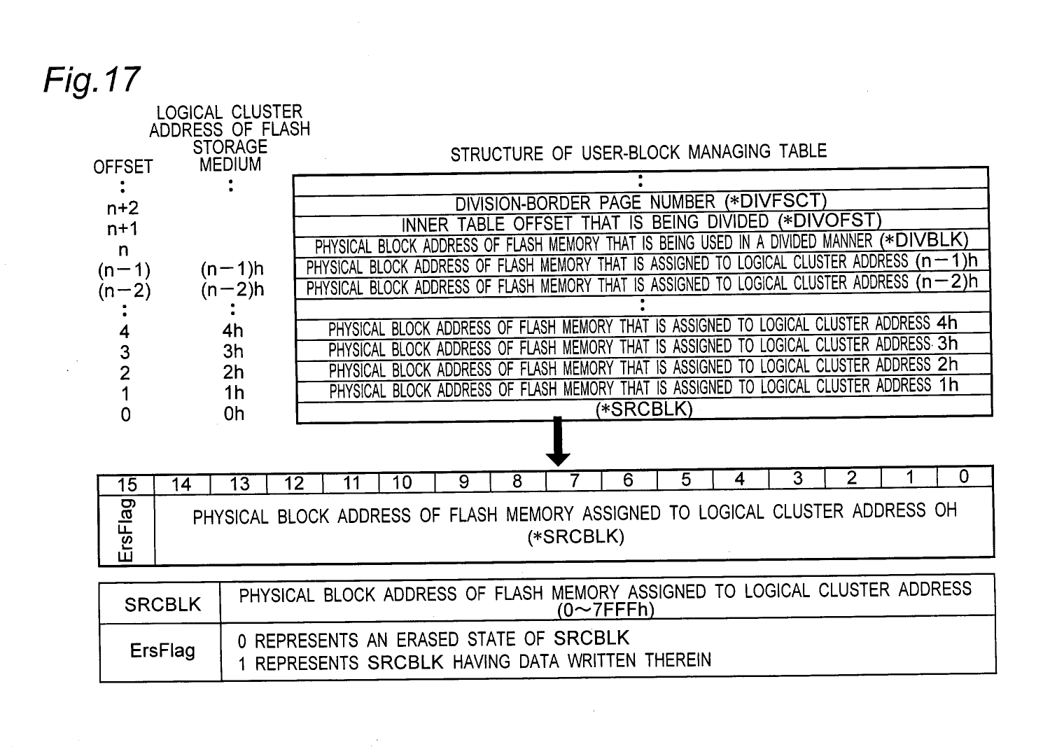

In a second embodiment, the hard construction of a flash storage medium is the same as that of the first embodiment; however, the operation of a program controlled by the CPU is different from that of the first embodiment. As shown in FIG. 17, the user-block managing table is provided with a flag ErsFlag that shows an erased state of a physical block address of a flash memory that is assigned to a logical cluster address. FIG. 17 shows a physical block address SRCBLK of a flash memory that is assigned to logical cluster address 0h. When this flag ErsFlag is 0, it represents that the SRCBLK is in an erased state, and when this ErsFlag is 1, it represents that the SRCBLK has data written therein.

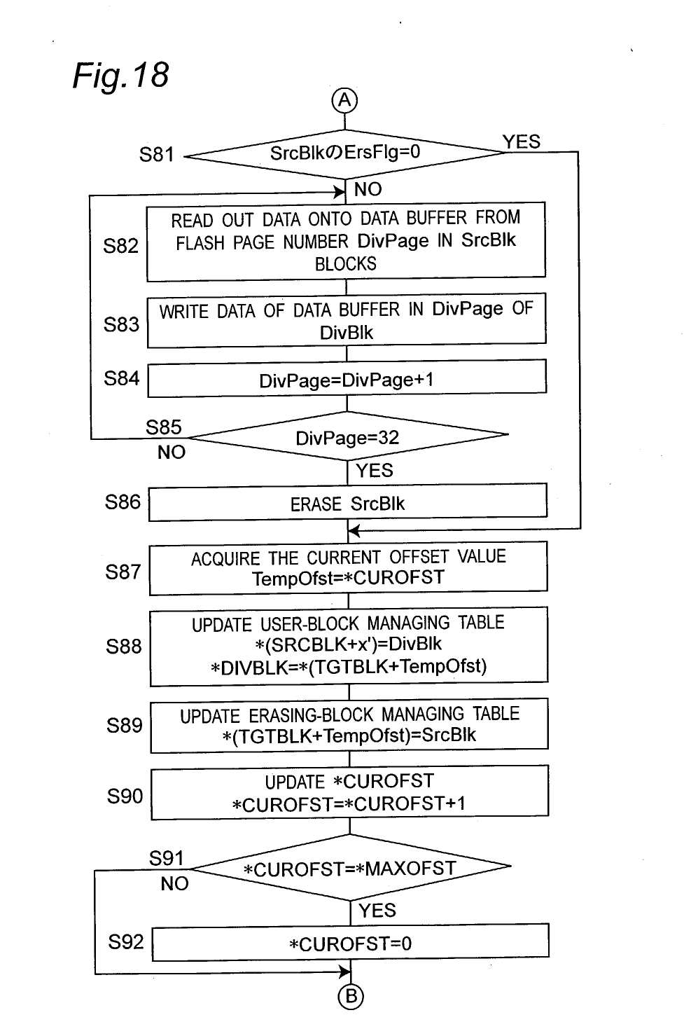

FIGS. 18 to 20, which relate to the second embodiment, are flow charts that show inner processes of the flash storage medium which are carried out upon receipt of a data writing request to a logical address xh from the host apparatus. Here, from the start to S81 shown in FIG. 18, the same flows as the first embodiment shown in FIG. 9 are carried out; therefore, the description thereof is omitted.

At S81, it is determined whether or not the flag ErsFlg with respect to the physical block address SrcBlk of the flash memory assigned to the logical cluster address x′h is 0. If it is NO, the sequence proceeds to S82, while, if it is YES, the sequence proceeds to S87.

At S82, data is read out onto the data buffer 5 based upon the division-border page number DivPage of the above-mentioned physical block address SrcBlk.

At S83, the data of the data buffer 5 is written in the division-border page number DivPage of the physical block address DivBlk that is being divided.

Successively, at S84, the division-border page number DivPage is updated (DivPage=DivPage+1).

At S85, it is determined whether or not the division border page number DivPage is 32 (DivPage=32). If it is YES, the sequence proceeds to S86, while, if it is NO, the sequence returns to S82 where the succeeding processes are repeated.

At S86, the above-mentioned physical block address SrcBlk is erased.

At S87, the current offset value *CUROFST is obtained as the offset value TempOfst. In this case, the following equation holds:

TempOfst=*CUROFST

At S88, the user-block managing table is updated. In this case, the following equations are used.

*(SRCBLK+x′)=DivBlk

*DIVBLK=*(TGTBLK+TempOfst)

At S89, the erasing-block managing table is updated. In this case, the following equation is used:

*(TGTBLK+TempOfst)=SrcBlk

Moreover, at S90, the current offset value *CUROFST in the erasing-block managing table is updated (*CUROFST=*CUROFST+1).

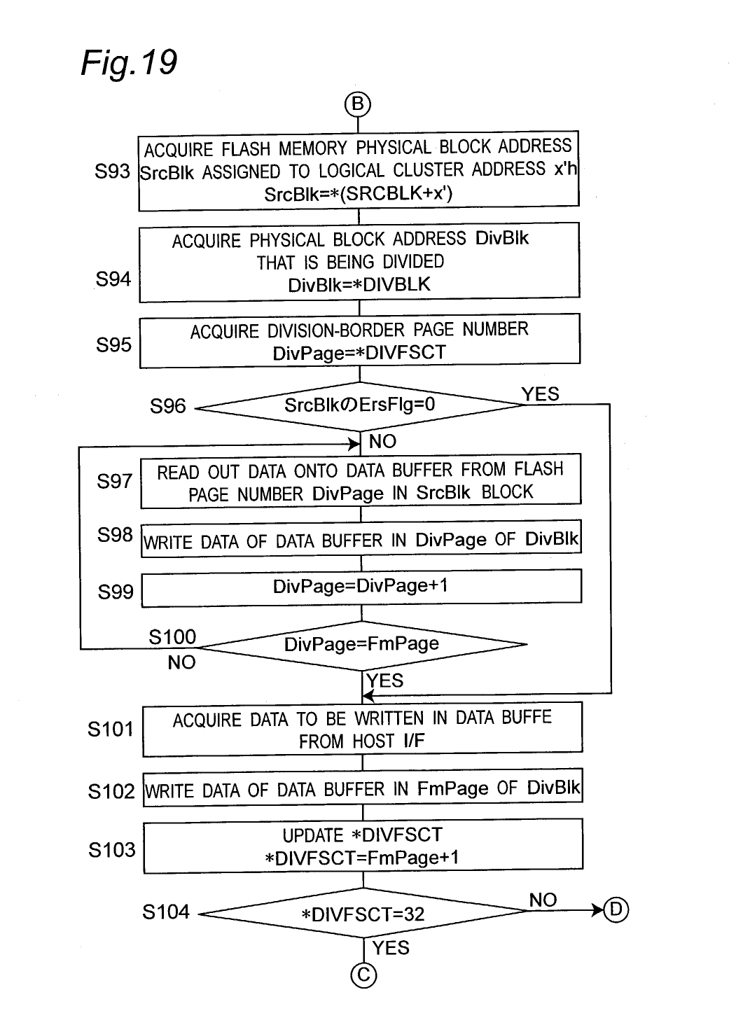

Next, at S91, it is determined whether or not the current offset value *CUROFST in the erasing-block managing table is equal to the maximum offset value *MAXOFST in the erasing-block managing table (*CUROFST=*MAXOFST). If it is YES, the sequence proceeds to S92 where *CUROFST=0 has been set, and the sequence proceeds to S93 in FIG. 19 through B in the figure. In contrast, if it is NO, the sequence directly proceeds to S93.

At S93, the physical block address SrcBlk assigned to the logical cluster address x′h is obtained (SrcBlk=*(SRCBLK+x′)).

At S94, the physical block address DivBlk that is being divided is obtained (DivBlk=*DIVBLK).

At S95, the division-border page number DivPage is obtained (DivPage=*DIVFSCT).

At S96, it is determined whether or not the flag ErsFIg of the above-mentioned physical block address SrcBlk is 0 (ErsFIg=0). If it is NO, the sequence proceeds S97, while, if it is YES, the sequence proceeds to S101.

At S97, data is read out onto data buffer 5 from the page number DivPage of the flash memory in blocks of the above-mentioned physical block address SrcBlk.

At S98, the data of the data buffer 5 is written in the division-border page number DivPage of the above-mentioned physical block address DivBlk.

At S99, the division-border page number DivPage is updated (DivPage=DivPage+1).

At S100, it is determined whether or not the division-border page number DivPage is equal to the page number FmPage of the flash memory in the block (DivPage=FmPage). If it is YES, the sequence proceeds to S101, while, if it is NO, the sequence returns to S97 where the succeeding processes are repeated.

At S101, data to be written in the data buffer 5 is acquired from the host I/F7.

At S102, the data of the data buffer 5 is written in the page number FmPage of the flash memory in the block of the physical block address DivBlk that is being divided.

At S103, the value *DIVFSCT of the above-mentioned division-border page number is updated. In this case, the following equation is used:

*DIVFSCT=FmPage+1

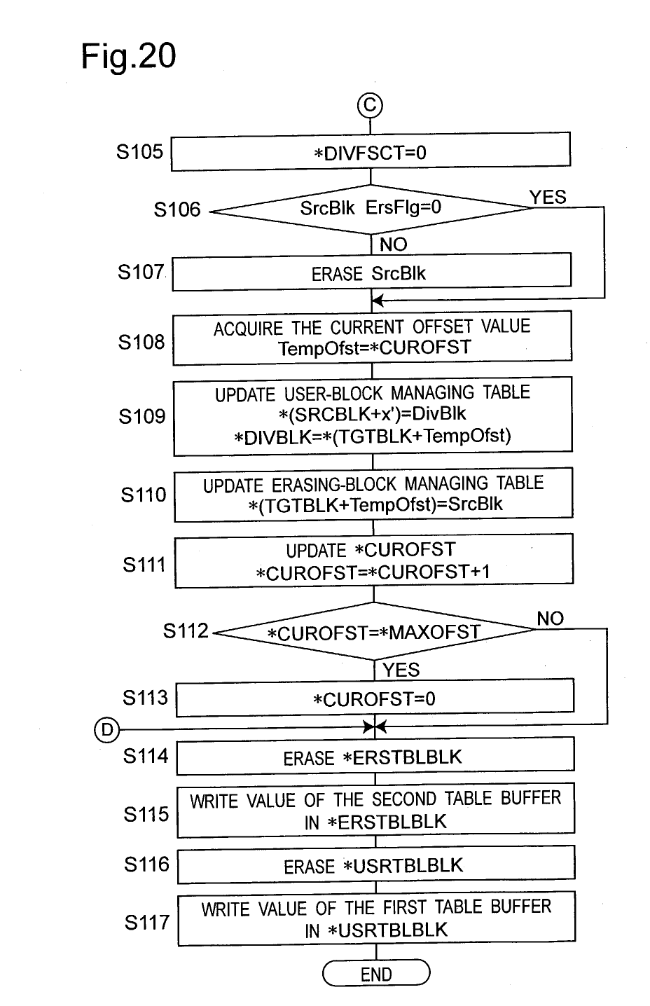

At S104, it is determined whether or not the value *DIVFSCT of the above-mentioned division-border page number is 32 (*DIVFSCT=32). If it is YES, the sequence proceeds to S105 of FIG. 20 through C in the figure, while, if it is NO, the sequence proceeds to S114 of FIG. 20 through D in the figure.

At S105, the above-mentioned value *DIVFSCT of the division-border page number is set to 0, and at S106, it is determined whether or not the flag ErsFIg of the physical block address SrcBlk is 0 (ErsFIg=0). If it is NO, the sequence proceeds to S107, and after the above-mentioned physical block address SrcBlk has been erased, the sequence proceeds to S108. In contrast, if it is YES, the sequence directly proceeds to S108.

At S108, by setting the offset value as TempOfst, the current offset value *CUROFST is acquired (TempOfst=*CUROFST).

At S109, the user-block managing table is updated. In this case, the following equations are used:

*(SRCBLK+x′)=DivBlk

*DIVBLK=*(TGTBLK+TempOfst)

At S110, the erasing-block managing table is updated. In this case, the following equation is used:

*(TGTBLK+TempOfset)=SrcBlk

At S111, the current offset value *CUROFST in the erasing-block managing table is updated (*CUROFST=*CUROFST+1).

At S112, it is determined whether or not the value of *CUROFST is equal to the maximum offset value *MAXOFST in the erasing-block managing table (*CUROFST=*MAXOFST). If it is YES, the sequence proceeds to S113 where, after *CUROFST=0 has been set, the sequence proceeds to S114. In contrast, if it is NO, the sequence directly proceeds to S114.

At S114, the physical block address *ERSTBLBLK of the flash memory in which the erasing-block managing table has been stored is erased.

At S115, the value of the second table buffer 4 is written in the above-mentioned physical block address *ERSTBLBLK.

At S116, the physical block address *USRTBLBLk of the flash memory in which the user-block managing table has been stored is erased.

At S117, the value of the first table buffer 3 is written in the above-mentioned physical block address *USRTBLBLK.

Thus, the process is completed.

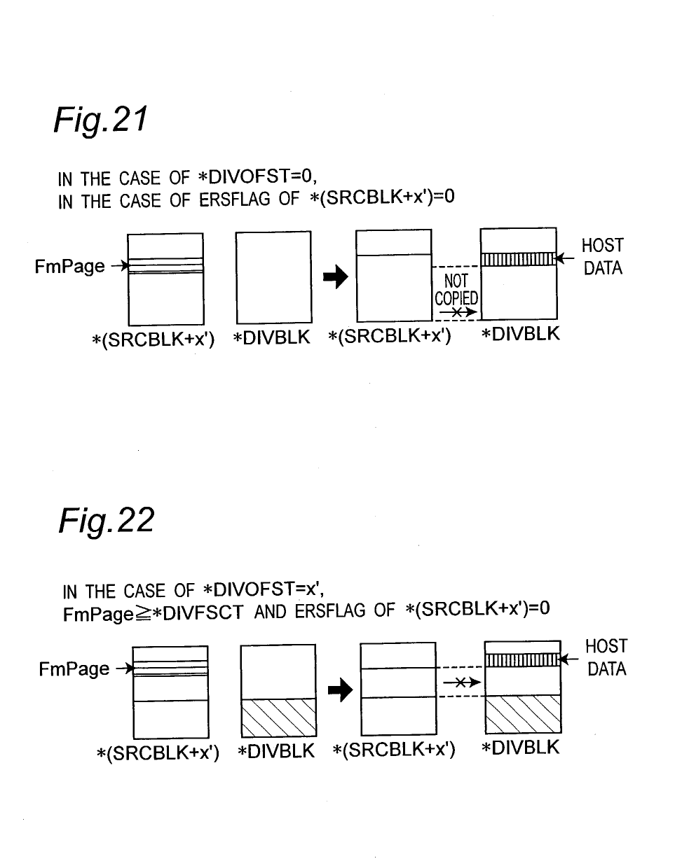

FIGS. 21 to 23 conceptually indicate data-writing operations in accordance with the inner processes by using flowcharts of FIGS. 18 to 20.

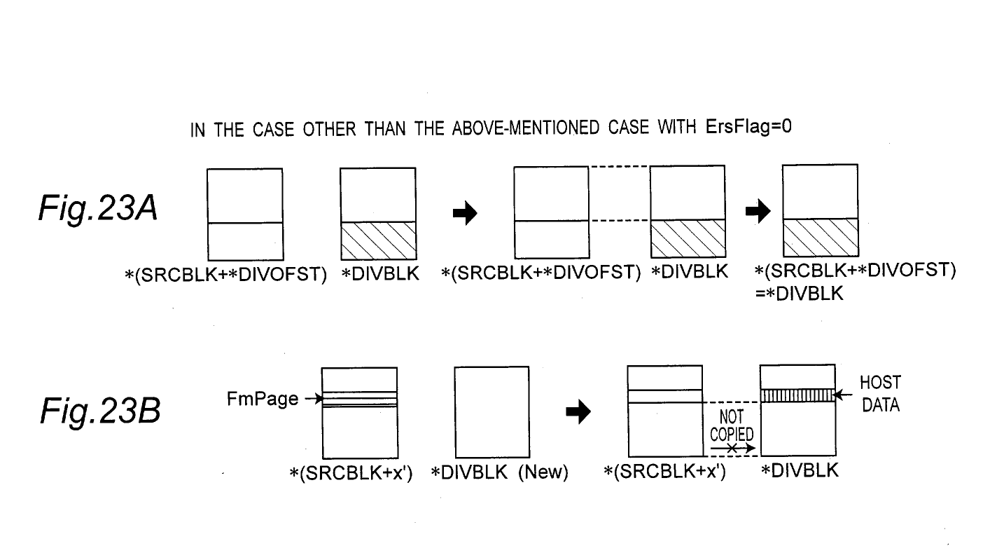

FIG. 21 shows a data-writing operation in the case when the value *DIVOFST of the inner table offset that is being divided within the user-block managing table is 0 and ErsFlag of (SRCBLK+x′) is 0. Further, FIG. 22 shows a data-writing operation in the case when *DIVOFST=x′, FmPage≧*DIVFSCT and ErsFlag of (SRCBLK+x′)=0. Moreover, FIGS. 23A and 23B show data-writing operations in the case of ErsFlag=0 under conditions other than those shown in FIGS. 21 and 22.

As described above, the flow during a writing process is changed depending on erasing states of flash memory physical block addresses assigned to the logical cluster addresses so that it is possible to eliminate wasteful copying processes as shown in FIGS. 21 to 23, and consequently to improve writing performances.

While the invention has been shown and described in detail, the foregoing description is in all aspects illustrative and not restrictive. It is therefore understood that numerous other modifications and variations can be devised without departing from the scope of the invention.

What is claimed is:

1. A flash storage medium, which has a NAND-type flash memory with an access unit to the flash memory being smaller than an erasing unit of the flash memory, comprising:
means which converts logical sector addresses inputted from a predetermined host apparatus to logical cluster addresses constituted by a plurality of logical sector addresses, in order to control the inside of the medium based upon a cluster unit constituted by a plurality of sectors that form said access unit;
a user block area constituted by flash memory physical blocks that correspond to said logical cluster addresses, said area being specified in said flash memory;
an erasing block area constituted by flash memory physical blocks that have been set in an erased state, said area being specified in said flash memory;
means which, when there is a logical cluster address having two flash memory physical blocks that are associated with each other, and when effective data and ineffective data are respectively located on these two flash memory physical blocks, acquires flash memory physical blocks that are associated with each other from logical sector addresses inputted from the host apparatus; and
means which exchanges a flash memory physical block in said erasing block area and a flash memory physical block in said user block area.

2. The flash storage medium according to claim 1, further comprising:
means which determines whether the flash memory physical block in association with said logical cluster address is in an erasing state or an data-writing state; and
means which changes a processing flow inside the flash storage medium based upon the erasing state and the data-writing state of said flash memory physical block.
